(19) United States
(12) Patent Application Publication
(10) Pub. No.: US 2022/0198440 A1
(43) Pub. Date: Jun. 23, 2022

(54) Method, System, and Computer Program Product for Generating a Token for a User Based on Another Token of Another User

(71) Applicant: Visa International Service Association, San Francisco, CA (US)

(72) Inventors: Prasad Gajanan Kulkarni, Reading (GB); Nishantha Thantya Rao, Singapore (SG); Srikanth Yalakkayala, Singapore (SG); Kapil Kumar Tejra, Singapore (SG)

(21) Appl. No.: 17/126,909

(22) Filed: Dec. 18, 2020

(51) Int. Cl. G06Q 20/36; G06Q 20/02; G06Q 40/04; G06Q 20/42; G06Q 20/40; G06Q 40/02

(52) U.S. Cl. CPC G06Q 20/3672; G06Q 20/02; G06Q 40/04; G06Q 30/0185; G06Q 20/405; G06Q 40/02; G06Q 20/42

(57) ABSTRACT

Provided is a method for generating a token. The method may include receiving a token creation request from a first user device of a first user, wherein the token creation request comprises first payment token data associated with a first payment token provisioned to the first user device and monetary amount data associated with a monetary amount; communicating an approval request based on the token creation request to an issuer system; receiving an approval response based on the approval request from the issuer system; generating a second payment token based on the approval response; and communicating second payment token data associated with the second payment token to a second user device of a second user. A system and computer program product are also disclosed.

### BACKGROUND

### 1. Field

This disclosed subject matter relates generally to methods, systems, and computer program products for token generation and, in some particular embodiments or aspects, to a method, system, and computer program product for generating a token for a second user based on a token of a first user.

### 2. Technical Considerations

Tokens (e.g., payment tokens) have been increasing in popularity, e.g., as a form of making payments and transactions between users and merchants. However, if an individual does not have a payment account (e.g., a credit card account, a bank account associated with a debit card, and/or the like), it is not possible for that individual to obtain a token for use with transactions. A first individual with a token (e.g., a payment token associated with a credit card, debit card, and/or the like) may wish to allow a second individual to use the token (e.g., for purchases), but the first individual may not want to expose sensitive information (e.g., account identifiers, such as a primary account number (PAN) and/or the like), e.g., to prevent fraud, or may want to limit how the second individual could use the token. Therefore, there is a need for a technique for allowing a second user to make transactions associated with the first user's token with restrictions in place and/or without sending the second user the first user's sensitive information.

Additionally, prepaid cards are often provided as gifts from one person to another person. However, prepaid cards for transactions often require maintenance fees, such as a monthly maintenance fee, and may be required to be valid for a minimum period of time (e.g., at least two years and/or the like). These requirements force card issuers to maintain a network for such prepaid cards. Moreover, identifiers associated with such cards must not be reused for years in order to ensure the prepaid cards remain valid for the required period of time. This inability to reuse identifiers of prepaid cards can result in costly maintenance for the card issuers, and may require such card issuers to spend time and devote resources to maintaining the prepaid cards. The cards are also often in the form of a plastic card, which can have negative impacts on the environment. Therefore, there is a need for a technique to enable a digital replacement for prepaid card. Further, there is a need for a technique that allows transactions with such prepaid accounts to be performed by the original user and/or allows the original user to send an account identifier for prepaid transactions to other users.

### SUMMARY

Accordingly, it is an object of the presently disclosed subject matter to provide methods, systems, and computer program products for token generation that overcome some or all of the deficiencies identified above.

According to non-limiting embodiments or aspects, provided is a computer-implemented method for token creation for a second user. In some non-limiting embodiments or aspects, a computer-implemented method for token creation for a second user may include receiving, with at least one processor, a token creation request from a first user device of a first user, wherein the token creation request comprises first payment token data associated with a first payment token provisioned to the first user device and monetary amount data associated with a monetary amount; communicating, with the at least one processor, an approval request based on the token creation request to an issuer system; receiving, with the at least one processor, an approval response based on the approval request from the issuer system; generating, with the at least one processor, a second payment token based on the approval response; and communicating, with the at least one processor, second payment token data associated with the second payment token to a second user device of a second user.

In some non-limiting embodiments or aspects, the computer-implemented method may also include determining, with the at least one processor, a reference identifier of the first user based on the first payment token data, wherein the approval request comprises the reference identifier of the first user, wherein the issuer system determines an account number of the first user based on the reference identifier. Communicating the second payment token data to the second user device may include communicating, with the at least one processor, a notification to the second user device; receiving, with the at least one processor, a response from the second user device; and communicating, with the at least one processor, the second payment token data to the second user device based on the response.

In some non-limiting embodiments or aspects, the computer-implemented method may include receiving, with at least one processor, a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount; and determining, with the at least one processor, a sum of the current transaction amount of the current authorization request and each respective previous transaction amount of the at least one previous authorization request; determining, with at least one processor, the sum is less than or equal to the monetary amount; and communicating, with the at least one processor, a modified authorization request comprising the first payment token based on determining the sum is less than or equal to the monetary amount. The second payment token may be associated with an initial account balance equal to the monetary amount.

In some non-limiting embodiments or aspects, the computer-implemented method may include debiting, with the at least one processor, an account of the first user an amount equal to the monetary amount prior to communicating the approval request to the issuer system. Communicating the second payment token data to the second user device may include communicating, with the at least one processor, the second payment token data to the first user device, wherein the first user device communicates the second payment token data to the second user device.

According to non-limiting embodiments or aspects, provided is a system for token creation for a second user. In some non-limiting embodiments or aspects, the system for token creation for a second user may include at least one processor; and at least one non-transitory computer-readable medium including one or more instructions that, when executed by the at least one processor, cause the at least one processor to receive a token creation request from a first user device of a first user, wherein the token creation request comprises first payment token data associated with a first payment token provisioned to the first user device and monetary amount data associated with a monetary amount; communicate an approval request based on the token creation request to an issuer system; receive an approval response based on the approval request from the issuer system; generate a second payment token based on the approval response; and communicate second payment token data associated with the second payment token to a second user device of a second user.

In some non-limiting embodiments or aspects, the system may include determining a reference identifier of the first user based on the first payment token data, wherein the approval request comprises the reference identifier of the first user, wherein the issuer system determines an account number of the first user based on the reference identifier. Communicating the second payment token data to the second user device may include communicating a notification to the second user device, receiving a response from the second user device; and communicating the second payment token data to the second user device based on the response.

In some non-limiting embodiments or aspects, the system may include receiving a plurality of authorization requests comprising the second payment token, the plurality of authorization requests comprising a current authorization request and at least one previous authorization request, the current authorization request comprising a current transaction amount, and each previous authorization request comprising a respective previous transaction amount; and determining a sum of the current transaction amount of the current authorization request and each respective previous transaction amount of the at least one previous authorization request; determining the sum is less than or equal to the monetary amount; and communicating a modified authorization request comprising the first payment token based on determining the sum is less than or equal to the monetary amount. The second payment token may be associated with an initial account balance equal to the monetary amount.

In some non-limiting embodiments or aspects, the system may include debiting an account of the first user an amount equal to the monetary amount prior to communicating the approval request to the issuer system. Communicating the second payment token data to the second user device may include communicating the second payment token data to the first user device, wherein the first user device communicates the second payment token data to the second user device.

According to non-limiting embodiments or aspects, provided is a computer program product for token creation for a second user. The computer program product may include at least one non-transitory computer-readable medium including one or more instructions that, when executed by at least one processor, cause the at least one processor to receive a token creation request from a first user device of a first user, wherein the token creation request comprises first payment token data associated with a first payment token provisioned to the first user device and monetary amount data associated with a monetary amount; communicate an approval request based on the token creation request to an issuer system; receive an approval response based on the approval request from the issuer system; generate a second payment token based on the approval response; and communicate second payment token data associated with the second payment token to a second user device associated with a second user.

In some non-limiting embodiments or aspects, the computer program product may include one or more instructions that, when executed by at least one processor, cause the at least one processor to determine a reference identifier of the first user based on the first payment token data, wherein the approval request comprises the reference identifier of the first user, wherein the issuer system determines an account number of the first user based on the reference identifier. Communicating the second payment token data to the second user device may include communicate a notification to the second user device; receive a response from the second user device; and communicate the second payment token data to the second user device based on the response.

In some non-limiting embodiments or aspects, the computer program product may include one or more instructions that, when executed by at least one processor, cause the at least one processor to receive a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount; determine a sum of the current transaction amount of the current authorization request and each respective previous transaction amount of the at least one previous authorization request; determine the sum is less than or equal to the monetary amount; and communicate a modified authorization request comprising the first payment token based on determining the sum is less than or equal to the monetary amount.

In some non-limiting embodiments or aspects, the second payment token may be associated with an initial account balance equal to the monetary amount. Communicating the second payment token data to the second user device may include communicating the second payment token data to the first user device, wherein the first user device communicates the second payment token data to the second user device.

Further embodiments or aspects are set forth in the following numbered clauses:

Clause 1: A computer-implemented method, comprising: receiving, with at least one processor, a token creation request from a first user device of a first user, wherein the token creation request comprises first payment token data associated with a first payment token provisioned to the first user device and monetary amount data associated with a monetary amount; communicating, with the at least one processor, an approval request based on the token creation request to an issuer system; receiving, with the at least one processor, an approval response based on the approval request from the issuer system; generating, with the at least one processor, a second payment token based on the approval response; and communicating, with the at least one processor, second payment token data associated with the second payment token to a second user device of a second user.

Clause 2: The computer-implemented method of clause 1, further comprising: determining, with the at least one processor, a reference identifier of the first user based on the first payment token data, wherein the approval request comprises the reference identifier of the first user, wherein the issuer system determines an account number of the first user based on the reference identifier.

Clause 3: The computer-implemented method of clauses 1 or 2, wherein communicating the second payment token data to the second user device comprises: communicating, with the at least one processor, a notification to the second user device; receiving, with the at least one processor, a response from the second user device; and communicating, with the at least one processor, the second payment token data to the second user device based on the response.

Clause 4: The computer-implemented method of any of clauses 1-3, wherein the method further comprises: receiving, with the at least one processor, a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount; determining, with the at least one processor, a sum of the current transaction amount of the current authorization request and each respective previous transaction amount of the at least one previous authorization request; determining, with the at least one processor, the sum is less than or equal to the monetary amount; and communicating, with the at least one processor, a modified authorization request comprising the first payment token based on determining the sum is less than or equal to the monetary amount.

Clause 5: The computer-implemented method of any of clauses 1-4, wherein the second payment token is associated with an initial account balance equal to the monetary amount.

Clause 6: The computer-implemented method of any of clauses 1-5, further comprising: debiting, with the at least one processor, an account of the first user an amount equal to the monetary amount prior to communicating the approval request to the issuer system.

Clause 7: The computer-implemented method of any of clauses 1-6, wherein communicating the second payment token data to the second user device further comprises: communicating, with the at least one processor, the second payment token data to the first user device, wherein the first user device communicates the second payment token data to the second user device.

Clause 8: A system, comprising: at least one processor; and at least one non-transitory computer-readable medium including one or more instructions that, when executed by the at least one processor, cause the at least one processor to: receive a token creation request from a first user device of a first user, wherein the token creation request comprises first payment token data associated with a first payment token provisioned to the first user device and monetary amount data associated with a monetary amount; communicate an approval request based on the token creation request to an issuer system; receive an approval response based on the approval request from the issuer system; generate a second payment token based on the approval response; and communicate second payment token data associated with the second payment token to a second user device of a second user.

Clause 9: The system of clause 8, wherein the one or more instructions further cause the at least one processor to: determine a reference identifier of the first user based on the first payment token data, wherein the approval request comprises the reference identifier of the first user, wherein the issuer system determines an account number of the first user based on the reference identifier.

Clause 10: The system of clauses 8 or 9, wherein communicating the second payment token data to the second user device comprises: communicating a notification to the second user device; receiving a response from the second user device; and communicating the second payment token data to the second user device based on the response.

Clause 11: The system of any of clauses 8-10, wherein the one or more instructions further cause the at least one processor to: receive a plurality of authorization requests comprising the second payment token, the plurality of authorization requests comprising a current authorization request and at least one previous authorization request, the current authorization request comprising a current transaction amount, and each previous authorization request comprising a respective previous transaction amount; determine a sum of the current transaction amount of the current authorization request and each respective previous transaction amount of the at least one previous authorization request; determine the sum is less than or equal to the monetary amount; and communicate a modified authorization request comprising the first payment token based on determining the sum is less than or equal to the monetary amount.

Clause 12: The system of any of clauses 8-11, wherein the second payment token is associated with an initial account balance equal to the monetary amount.

Clause 13: The system of any of clauses 8-12, wherein the one or more instructions further cause the at least one processor to: debit an account of the first user an amount equal to the monetary amount prior to communicating the approval request to the issuer system.

Clause 14: The system of any of clauses 8-13, wherein communicating the second payment token data to the second user device further comprises: communicating the second payment token data to the first user device, wherein the first user device communicates the second payment token data to the second user device.

Clause 15: A computer program product comprising at least one non-transitory computer-readable medium including one or more instructions that, when executed by at least one processor, cause the at least one processor to: receive a token creation request from a first user device of a first user, wherein the token creation request comprises first payment token data associated with a first payment token provisioned to the first user device and monetary amount data associated with a monetary amount; communicate an approval request based on the token creation request to an issuer system; receive an approval response based on the approval request from the issuer system; generate a second payment token based on the approval response; and communicate second payment token data associated with the second payment token to a second user device associated with a second user.

Clause 16: The computer program product of clause 15, wherein the one or more instructions further cause the at least one processor to: determine a reference identifier of the first use based on the first payment token data, wherein the approval request comprises the reference identifier of the first user, wherein the issuer system determines an account number of the first user based on the reference identifier.

Clause 17: The computer program product of clauses 15 or 16, wherein communicating the second payment token data to the second user device comprises: communicating a notification to the second user device; receiving a response from the second user device; and communicating the second payment token data to the second user device based on the response.

Clause 18: The computer program product of any of clauses 15-17, wherein the one or more instructions further cause the at least one processor to: receive a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount; determine a sum of the current transaction amount of the current authorization request and each respective previous transaction amount of the at least one previous authorization request; determine the sum is less than or equal to the monetary amount; and communicate a modified authorization request comprising the first payment token based on determining the sum is less than or equal to the monetary amount.

Clause 19: The computer program product of any of clauses 15-18, wherein the second payment token is associated with an initial account balance equal to the monetary amount.

Clause 20: The computer program product of any of clauses 15-19, wherein communicating the second payment token data to the second user device further comprises: communicating the second payment token data to the first user device, wherein the first user device communicates the second payment token data to the second user device.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which methods, systems, and/or computer program products, described herein, may be implemented according to the principles of the presently disclosed subject matter;

FIG. 2 is a diagram of a non-limiting embodiment or aspects of components of one or more devices of FIG. 1;

FIG. 3 is a flowchart of a non-limiting embodiment or aspect of a process for token creation for a second user according to the principles of the presently disclosed subject matter;

FIG. 4 is a diagram of a non-limiting embodiment or aspect of an implementation of a non-limiting embodiment or aspect of the process shown in FIG. 3 according to the principles of the presently disclosed subject matter;

FIGS. 5A and 5B are diagrams of non-limiting embodiments or aspects of implementations of non-limiting embodiments or aspects of the process shown in FIG. 3 according to the principles of the presently disclosed subject matter;

FIG. 6 is a diagram of a non-limiting embodiment or aspect of an implementation of a non-limiting embodiment or aspect of the process shown in FIG. 3 according to the principles of the presently disclosed subject matter; and

FIG. 7 is a diagram of a non-limiting embodiment or aspect of an implementation of a non-limiting embodiment or aspect of the process shown in FIG. 3 according to the principles of the presently disclosed subject matter.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “token requestor” may refer to an entity that is seeking to implement tokenization according to embodiments or aspects of the presently disclosed subject matter. For example, the token requestor may initiate a request that a PAN be tokenized by submitting a token request message to a token service provider. Additionally or alternatively, a token requestor may no longer need to store a PAN associated with a token once the requestor has received the payment token in response to a token request message. In some non-limiting embodiments or aspects, the requestor may be an application, a device, a process, or a system that is configured to perform actions associated with tokens. For example, a requestor may request registration with a network token system, request token generation, token activation, token de-activation, token exchange, other token lifecycle management related processes, and/or any other token related processes. In some non-limiting embodiments or aspects, a requestor may interface with a network token system through any suitable communication network and/or protocol (e.g., using HTTPS, SOAP, and/or an XML interface among others). For example, a token requestor may include card-on-file merchants, acquirers, acquirer processors, payment gateways acting on behalf of merchants, payment enablers (e.g., original equipment manufacturers, mobile network operators, and/or the like), digital wallet providers, issuers, third-party wallet providers, payment processing networks, and/or the like. In some non-limiting embodiments or aspects, a token requestor may request tokens for multiple domains and/or channels. Additionally or alternatively, a token requestor may be registered and identified uniquely by the token service provider within the tokenization ecosystem. For example, during token requestor registration, the token service provider may formally process a token requestor's application to participate in the token service system. In some non-limiting embodiments or aspects, the token service provider may collect information pertaining to the nature of the requestor and relevant use of tokens to validate and formally approve the token requestor and establish appropriate domain restriction controls. Additionally or alternatively, successfully registered token requestors may be assigned a token requestor identifier that may also be entered and maintained within the token vault. In some non-limiting embodiments or aspects, token requestor identifiers may be revoked and/or token requestors may be assigned new token requestor identifiers. In some non-limiting embodiments or aspects, this information may be subject to reporting and audit by the token service provider.

As used herein, the term “token service provider” may refer to an entity including one or more server computers in a token service system that generates, processes, and maintains payment tokens. For example, the token service provider may include or be in communication with a token vault where the generated tokens are stored. Additionally or alternatively, the token vault may maintain one-to-one mapping between a token and a PAN represented by the token. In some non-limiting embodiments or aspects, the token service provider may have the ability to set aside licensed BINs as token BINs to issue tokens for the PANs that may be submitted to the token service provider. In some non-limiting embodiments or aspects, various entities of a tokenization ecosystem may assume the roles of the token service provider. For example, payment networks and issuers or their agents may become the token service provider by implementing the token services according to non-limiting embodiments or aspects of the presently disclosed subject matter. Additionally or alternatively, a token service provider may provide reports or data output to reporting tools regarding approved, pending, or declined token requests, including any assigned token requestor ID. The token service provider may provide data output related to token-based transactions to reporting tools and applications and present the token and/or PAN as appropriate in the reporting output. In some non-limiting embodiments or aspects, the EMVCo standards organization may publish specifications defining how tokenized systems may operate. For example, such specifications may be informative, but they are not intended to be limiting upon any of the presently disclosed subject matter.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting embodiments or aspects, the token vault may be a part of a token service system. For example, the token vault may be provided as a part of the token service provider. Additionally or alternatively, the token vault may be a remote repository accessible by the token service provider. In some non-limiting embodiments or aspects, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed and/or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user (e.g. user device), and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, a user, and/or the like) that owns, utilizes, and/or operates a client device for initiating transactions (e.g., for initiating transactions with a transaction service provider).

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Non-limiting embodiments or aspects of the disclosed subject matter are directed to systems, methods, and computer program products for token creation, including, but not limited to, generating a token for a second user. For example, non-limiting embodiments or aspects of the disclosed subject matter provide generating a second token linked to the token of the first user, or generating a prepaid token after debiting the prepaid token balance from the first user's token. In some non-limiting embodiments or aspects, a first user may initiate the creation of a second token for use of a second user with customizable controls, e.g., validity time of the token, total amount limit of transactions, and currency of the token. Additionally or alternatively, the token restrictions may also optionally include at least one merchant name. Additionally or alternatively, the second token may be linked to a token associated with the first user such that the transaction initiated with the second token may be debited to the first user's token. The customizable controls allow for increased security for the first user as it can restrict how and when transactions are made with the second token. Additionally, the creation of the second token may be initiated without disclosing sensitive information (e.g., the PAN of the first user, other account identifier(s) of the first user, and/or the like) to the second user or to any merchants to which the second token is provided. The ability to provision a token for the second user may provide easier and increased access to tokens. As such, use of such tokens may increase, and this increased use may actually result in less time and resources being devoted by issuers (e.g., of prepaid cards and/or the like), since the tokens are digital and have customizable controls (e.g., compared to plastic cards with expiration date requirements and/or that prevent reusing account numbers). The use of such tokens may also result in less time and resources devoted by issuers because it will allow for quicker recycling of card numbers, allowing the issuer to maintain a smaller number of overall card numbers necessary for the digital tokens. The use of prepaid tokens may provide additional security compared to traditional prepaid cards. The prepaid tokens may require identification procedures to reduce the prevalence of money laundering. The prepaid tokens will not be able to be lost or stolen, such as the ways a physical plastic card can be taken and/or information from the prepaid card can be copied through card skimmers. A user may wish to purchase a prepaid token for himself. In non-limiting embodiments or aspects, the prepaid token may be in a currency of an intended travel destination. This will allow the user to spend in the local currency during an intended travel period while preventing the use of their PAN information. This would be beneficial if the user is traveling to an area where the risk of credit card fraud is more common, which would normally put the user at an increased risk of getting their PAN stolen during transactions in the travel destination. Use of the prepaid tokens allows increased security to the user as it will limit the amount of funds that may be lost due to fraud. The maximum amount a user could potentially lose would be the balance of the prepaid token, and any fraud committed against the prepaid token would not expose the user's sensitive information (e.g., PAN, other account identifiers, and/or the like associated with the user's original token) to the fraudsters. The tokens provide environmental benefits as they can be given to users without the use of plastic cards. The tokens may be used in festivals or special events. The tokens can allow currency to be sent as a gift in a secure manner. The tokens can allow the gift of currency to occur in a short amount of time. This can allow for increased efficiency and convenience for individuals to provide methods of payment.

For the purpose of illustration, in the following description, while the presently disclosed subject matter is described with respect to methods, systems, and computer program products for generating tokens for a second user, one skilled in the art will recognize that the disclosed subject matter is not limited to the illustrative embodiments or aspects. For example, the methods, systems, and computer program products described herein may be used with a wide variety of settings, such as festivals, special events, and general everyday use in any setting suitable for using such tokens.

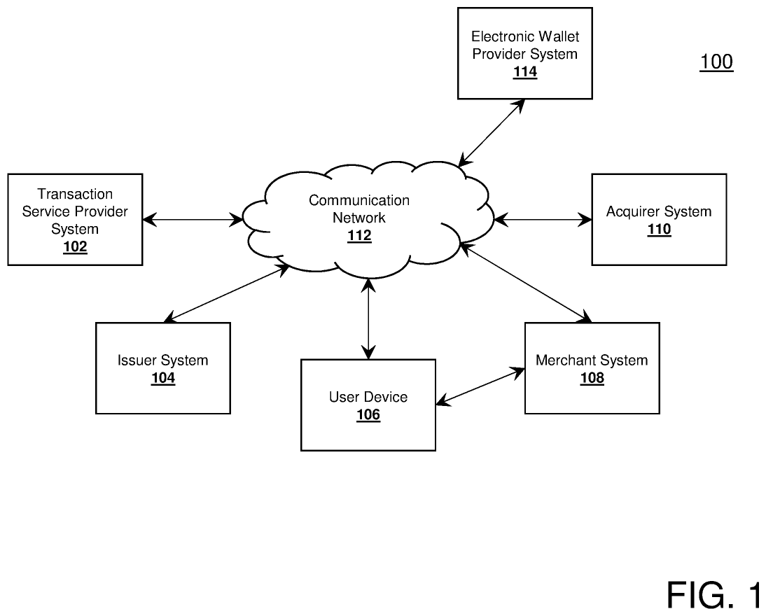

Referring now to FIG. 1, FIG. 1 is a diagram of a non-limiting embodiment or aspect of an environment 100 in which systems, products, and/or methods, as described herein, may be implemented. As shown in FIG. 1, environment 100 includes transaction service provider system 102, issuer system 104, user device 106, merchant system 108, acquirer system 110, electronic wallet provider system 114, and communication network 112.

Transaction service provider system 102 may include one or more devices capable of receiving information from and/or communicating information to issuer system 104, user device 106, merchant system 108, electronic wallet provider system 114, and/or acquirer system 110 via communication network 112. For example, transaction service provider system 102 may include a computing device, such as a server (e.g., a transaction processing server), a group of servers, and/or other like devices. In some non-limiting embodiments or aspects, transaction service provider system 102 may be associated with a transaction service provider as described herein. In some non-limiting embodiments or aspects, transaction service provider system 102 may be in communication with a data storage device, which may be local or remote to transaction service provider system 102. In some non-limiting embodiments or aspects, transaction service provider system 102 may be capable of receiving information from, storing information in, communicating information to, or searching information stored in the data storage device.

Issuer system 104 may include one or more devices capable of receiving information and/or communicating information to transaction service provider system 102, user device 106, merchant system 108, electronic wallet provider system 114, and/or acquirer system 110 via communication network 112. For example, issuer system 104 may include a computing device, such as a server, a group of servers, and/or other like devices. In some non-limiting embodiments or aspects, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or communicating information to transaction service provider system 102, issuer system 104, merchant system 108, electronic wallet provider system 114, and/or acquirer system 110 via communication network 112. Additionally or alternatively, each user device 106 may include a device capable of receiving information from and/or communicating information to other user devices 106 via communication network 112, another network (e.g., an ad hoc network, a local network, a private network, a virtual private network, and/or the like), and/or any other suitable communication technique. For example, user device 106 may include a client device and/or the like. In some non-limiting embodiments or aspects, user device 106 may or may not be capable of receiving information (e.g., from merchant system 108 or from another user device 106) via a short-range wireless communication connection (e.g., an NFC communication connection, an RFID communication connection, a Bluetooth® communication connection, a Zigbee® communication connection, and/or the like), and/or communicating information (e.g., to merchant system 108) via a short-range wireless communication connection.

Merchant system 108 may include one or more devices capable of receiving information from and/or communicating information to transaction service provider system 102, issuer system 104, user device 106, electronic wallet provider system 114, and/or acquirer system 110 via communication network 112. Merchant system 108 may also include a device capable of receiving information from user device 106 via communication network 112, a communication connection (e.g., an NFC communication connection, an RFID communication connection, a Bluetooth® communication connection, a Zigbee® communication connection, and/or the like) with user device 106, and/or the like, and/or communicating information to user device 106 via communication network 112, the communication connection, and/or the like. In some non-limiting embodiments or aspects, merchant system 108 may include a computing device, such as a server, a group of servers, a client device, a group of client devices, and/or other like devices. In some non-limiting embodiments or aspects, merchant system 108 may be associated with a merchant as described herein. In some non-limiting embodiments or aspects, merchant system 108 may include one or more client devices. For example, merchant system 108 may include a client device that allows a merchant to communicate information to transaction service provider system 102. In some non-limiting embodiments or aspects, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or communicating information to transaction service provider system 102, issuer system 104, user device 106, electronic wallet provider system 114, and/or merchant system 108 via communication network 112. For example, acquirer system 110 may include a computing device, a server, a group of servers, and/or the like. In some non-limiting embodiments or aspects, acquirer system 110 may be associated with an acquirer as described herein.

Electronic wallet provider system 114 may include one or more devices capable of receiving information from and/or communicating information to transaction service provider system 102, issuer system 104, user device 106, acquirer system 110, and/or merchant system 108 via communication network 112. For example, electronic wallet provider system 114 may include a computing device, a server, a group of servers, and/or the like. In some non-limiting embodiments or aspects, electronic wallet provider system 114 may be associated with an electronic wallet provider as described herein.

Communication network 112 may include one or more wired and/or wireless networks. For example, communication network 112 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, processing a transaction may include generating and/or communicating at least one transaction message (e.g., authorization request, authorization response, any combination thereof, and/or the like). For example, a client device (e.g., user device 106, a POS device of merchant system 108, and/or the like) may initiate the transaction, e.g., by generating an authorization request. Additionally or alternatively, the client device (e.g., user device 106, at least on device of merchant system 108, and/or the like) may communicate the authorization request. For example, user device 106 may communicate the authorization request to merchant system 108 and/or a payment gateway (e.g., a payment gateway of transaction service provider system 102, a third-party payment gateway separate from transaction service provider system 102, and/or the like). Additionally or alternatively, merchant system 108 (e.g., a POS device thereof) may communicate the authorization request to acquirer system 110 and/or a payment gateway. In some non-limiting embodiments or aspects, acquirer system 110 and/or a payment gateway may communicate the authorization request to transaction service provider system 102 and/or issuer system 104. Additionally or alternatively, transaction service provider system 102 may communicate the authorization request to issuer system 104. In some non-limiting embodiments or aspects, issuer system 104 may determine an authorization decision (e.g., authorize, decline, and/or the like) based on the authorization request. For example, the authorization request may cause issuer system 104 to determine the authorization decision based thereon. In some non-limiting embodiments or aspects, issuer system 104 may generate an authorization response based on the authorization decision. Additionally or alternatively, issuer system 104 may communicate the authorization response. For example, issuer system 104 may communicate the authorization response to transaction service provider system 102 and/or a payment gateway. Additionally or alternatively, transaction service provider system 102 and/or a payment gateway may communicate the authorization response to acquirer system 110, merchant system 108, and/or user device 106. Additionally or alternatively, acquirer system 110 may communicate the authorization response to merchant system 108 and/or a payment gateway. Additionally or alternatively, a payment gateway may communicate the authorization response to merchant system 108 and/or user device 106. Additionally or alternatively, merchant system 108 may communicate the authorization response to user device 106. In some non-limiting embodiments or aspects, merchant system 108 may receive (e.g., from acquirer system 110 and/or a payment gateway) the authorization response. Additionally or alternatively, merchant system 108 may complete the transaction based on the authorization response (e.g., provide, ship, and/or deliver goods and/or services associated with the transaction; fulfill an order associated with the transaction; any combination thereof; and/or the like).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

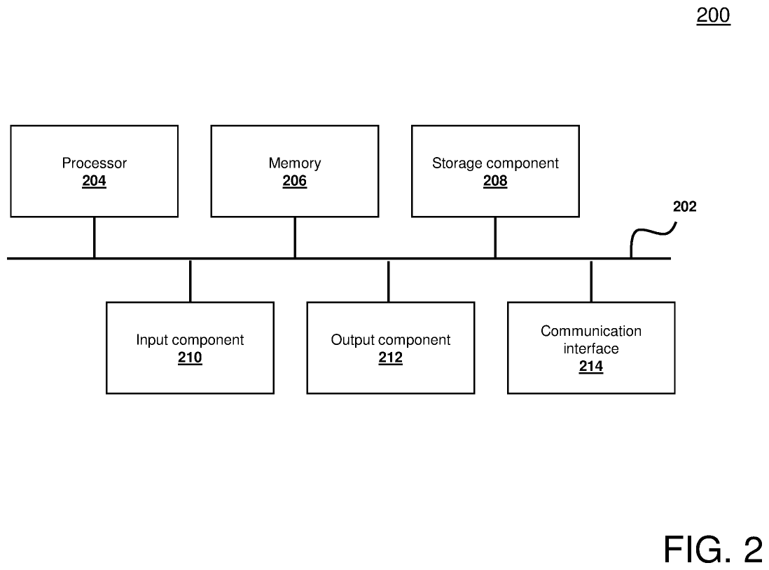

Referring now to FIG. 2, FIG. 2 is a diagram of example components of a device 200. Device 200 may correspond to one or more devices of transaction service provider system 102, one or more devices of issuer system 104, user device 106, one or more devices of merchant system 108, one or more devices of electronic wallet provider system 114, and/or one or more devices of acquirer system 110. In some non-limiting embodiments or aspects, transaction service provider system 102, issuer system 104, user device 106, merchant system 108, electronic wallet provider system 114, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, firmware, and/or any combination thereof. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

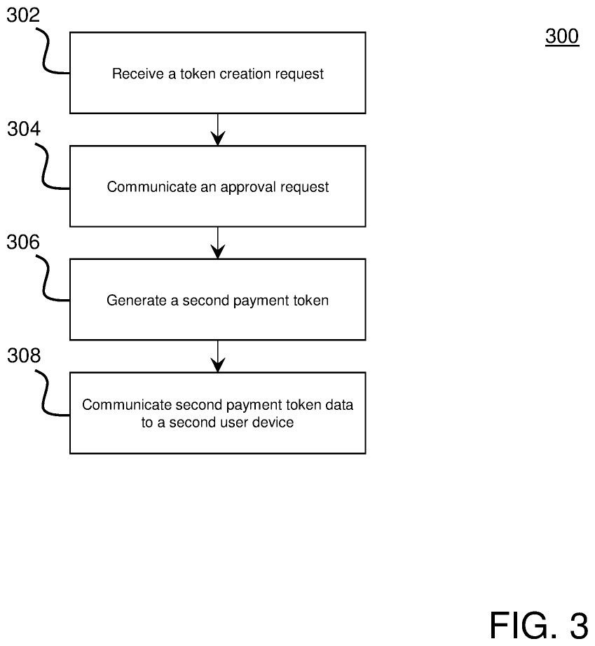

Referring now to FIG. 3, FIG. 3 is a flowchart of a non-limiting embodiment or aspect of a process 300 for creating a token for a second user. In some non-limiting embodiments or aspects, one or more of the steps of process 300 may be performed (e.g., completely, partially, and/or the like) by a transaction service provider system 102. In some non-limiting embodiments or aspects, one or more of the steps of process 300 may be performed (e.g., completely, partially, and/or the like) by another system, another device, another group of systems, or another group of devices, separate from or including transaction service provider system 102, issuer system 104, user device 106, merchant system 108, acquirer system 110, electronic wallet provider system 114, or any combination thereof, and/or the like.

As shown in FIG. 3, at step 302, process 300 may include receiving a token creation request. For example, transaction service provider system 102, electronic wallet provider system 114, and/or the like may receive the token creation request from a first user device 106 of a first user. Additionally or alternatively, the first user device 106 may communicate the token creation request to transaction service provider system 102, an electronic wallet provider system 114, and/or the like. In some non-limiting embodiments or aspects, the electronic wallet provider system 114 may communicate the token creation request to a transaction service provider system 102. The token creation request may include payment token data (e.g. account identifier, reference identifier, last four digits of a PAN, and/or the like) associated with a payment token provisioned to the user device 106 (e.g., a first payment token). The token creation request may also include monetary amount data associated with a monetary amount. The monetary amount data may include a currency of the monetary amount, a numerical value of the monetary amount, and/or the like. In some non-limiting embodiments or aspects, the monetary amount data may also designate the monetary amount as a cap or as a balance. The token creation request may also include merchant data, such as a merchant name, and validity data, such as a date in which validity of the token will expire. The token creation request may also include an identifier of a recipient, such as a user ID of the recipient.

With continued reference to FIG. 3, at step 304, process 300 may include communicating an approval request. For example, transaction service provider system 102 may communicate the approval request (e.g., to issuer system 104 and/or the like). The approval request may be based on the token creation request. The approval request may include an account identifier, monetary amount data, and/or the like. The approval request may be communicated to an issuer system 104. The approval request may be communicated by a transaction service provider system 102.

With continued reference to FIG. 3, at step 306, a payment token may be generated (e.g., a second payment token, a prepaid token, a generated token, and/or the like). For example, transaction service provider system 102, and/or the like may generate the (second) payment token. The payment token generated may be a separate token from the payment token provisioned to the user device included in the token creation request.

With continued reference to FIG. 3 at step 308, process 300 may include communicating the payment token data associated with the second payment token. For example, transaction service provider system 102 may communicate the second payment token to electronic wallet provider system 114, the first user device 106, a second user device 106 (e.g., a user device 106 associated with an intended recipient of the payment token), and/or the like. Additionally or alternatively, electronic wallet provider system 114 may communicate the second payment token to the first user device 106, a second user device 106 (e.g., a user device 106 associated with an intended recipient of the second payment token), and/or the like. The second user device 106 may be a separate device than the first user device 106 used to communicate the token creation request and may belong to a different user (e.g. a second user) than the first user. In some non-limiting embodiments or aspects, the payment token data associated with the second payment token may be communicated to the same user device 106 used to communicate the token creation request associated with the first user. The payment token data associated with the second payment token may include a token identifier.

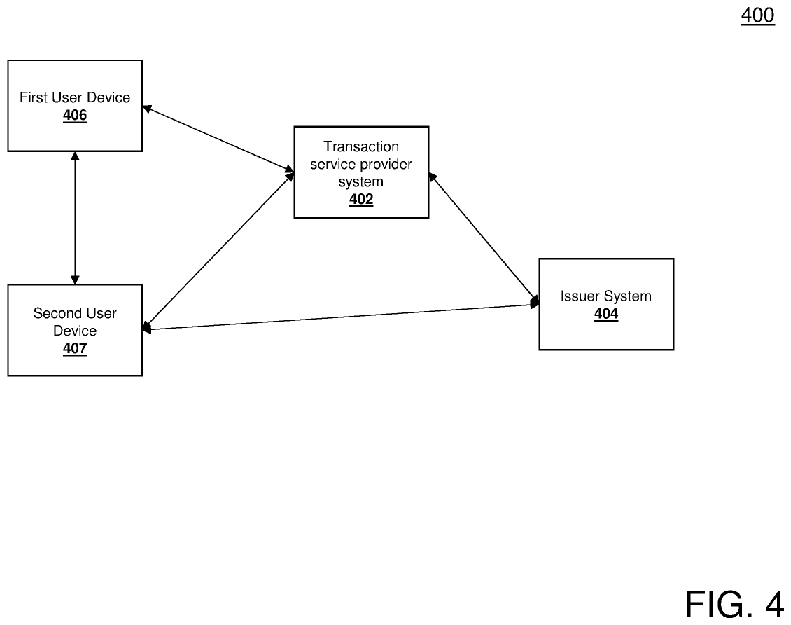

Referring now to FIG. 4, shown is a diagram of an exemplary implementation 400 of a non-limiting embodiment or aspect relating to process 300 shown in FIG. 3. As shown in FIG. 4, implementation 400 may include a first user device 406, a second user device 407, a transaction service provider system 402, an issuer system 404, and/or the like. In some non-limiting embodiments or aspects, first user device 406 and/or second user device 407 may be the same as or similar to user device 106. In some non-limiting embodiments or aspects, first user device 406 and second user device 407 may be the same device. In some non-limiting embodiments or aspects, transaction service provider system 402 may be the same as or similar to transaction service provider system 102. In some non-limiting embodiments or aspects, issuer system 404 may be the same as or similar to issuer system 104. A prepaid token may be the same as or similar to a second token associated with a prepaid account.

In some non-limiting embodiments or aspects, a first user may seek to provide a prepaid token (e.g. a second payment token and/or the like) to a second user. First user device 406, which may be associated with the first user, may communicate a token creation request for a prepaid token (e.g., based on input from the first user and/or the like). The token creation request may include payment token data associated with a payment token provisioned to the first user device 406 and/or monetary amount data. The token creation request may be communicated to a transaction service provider system 402. The transaction service provider system 402 may provide application programming interfaces (APIs) to the first user device 406 for purchasing prepaid tokens and tokenization. The APIs may allow the transaction service provider system 402 to receive and act upon data associated with the token creation request.

In some non-limiting embodiments or aspects, the token creation request may be registered using block chain protocols. Additionally or alternatively, the token creation request may be evaluated based on anti-money laundering rules and/or regulations.

In some non-limiting embodiments or aspects, the first user may communicate the token creation request by selecting one or more issuers from a list of predetermined businesses. The businesses may include issuers, merchants, banks, electronic wallet providers, and/or the like. The list of predetermined businesses may be determined based on the location of the first user device 406 or the list of predetermined businesses may be determined based on a location communicated by first user device 406 to the transaction service provider system 402. The location may be included in the token creation request. The list of predetermined businesses may be displayed on the first user device 406 through a mobile application, website, and/or the like. The list of predetermined businesses may be determined by the transaction service provider. The transaction service provider system 402 may provide APIs to the first user device 406 to provide the list of predetermined businesses. The mobile application, website, and/or the like may be associated with an electronic wallet provider, the transaction service provider, a merchant, a bank, and/or the like.

In some non-limiting embodiments or aspects, the first user may also select a monetary amount from a predetermined list of monetary amounts (e.g., $10, $25, $100, etc.) and/or may enter a customized value.

In some non-limiting embodiments or aspects, the first user may also select to associate the prepaid token for their own use, or for the use of a second user. The prepaid token may be restricted such that it can only be used with the selected issuer.

In some non-limiting embodiments or aspects, the transaction service provider system 402, upon receiving the token creation request, may communicate an approval request to an issuer system 404. Additionally or alternatively, the issuer system 404 may communicate an approval response (e.g., indicating an approval, denial, and/or the like) based on the approval request to the transaction service provider system 402. For example, the issuer system 404 may determine its approval based on the funds available associated with the payment token provisioned to the first user device 406 and/or the eligibility of the provisioned payment token. If the approval request is denied, no payment token will be generated. If the approval request is approved, the transaction service provider system 402 may generate a prepaid token (e.g., allocate a PAN for the prepaid token and/or the like). For example, a PAN may be selected from a predetermined range of PAN values designated for prepaid tokens. The transaction service provider system 402 may open an account with a balance (e.g., gift balance, prepaid balance, and/or the like) equal to the monetary amount selected by the first user for the token creation request. Additionally or alternatively, a debit equal to the gift balance may be charged (e.g., by transaction service provider system 402 and/or the like) to the account associated with the first user device 406 (e.g., the PAN associated with the first user's payment token and/or the like). For example, the debit may be charged to a bank account, a debit card, a credit card, a cash deposit, and/or the like. In some non-limiting embodiments or aspects, the debit may be charged (e.g., by transaction service provider system 402 and/or the like) to the first user prior to communicating the approval request to the issuer system 404.

In some non-limiting embodiments or aspects, transaction service provider system 402 may communicate a link to the first user device 406. The link may be accompanied with an image, an icon (e.g., a gift box icon and/or the like), a numerical amount, and/or the like. The link may not provide (e.g., not include and/or the like) account details (e.g., the payment token data of the first user device, an account identifier of the first user, and/or the like) of the first user.

In some non-limiting embodiments or aspects, the first user may be prompted to send the link to another user or use the link themselves (e.g., provision the prepaid token to the first user device 406). For example, if the first user has previously indicated that they will be using the prepaid token themselves (e.g., based on a selection for the token creation request), the link may be active. Additionally or alternatively, if the first user indicated that the prepaid token will be for a second user, the link may be inactive when received by first user device 406.

In some non-limiting embodiments or aspects, first user device 406 may communicate the link to second user device 407 associated with a second user. For example, the link may be communicated through a mobile application, SMS message, email, and/or the like. In some non-limiting embodiments or aspects, the first user may select the second user from the first user's contact list on first user device 406. In some non-limiting embodiments or aspects, first user device 406 may communicate contact data associated with second user device 407 to the transaction service provider system 402. The transaction service provider system 402 may then communicate the active link to the second user device 406 based on the contact data. The contact data may include a phone number, email address, name, mobile application account number, account identifier, PAN, and/or the like. In non-limiting embodiments, the link may be accompanied with instructions on how to register the prepaid token.

In some non-limiting embodiments or aspects, second user device 407 may communicate a response to first user device 406. Additionally or alternatively, the second user may select the active link through the second user device 407. The link may enable the second user to register the prepaid token. The prepaid token may be registered to the second user device 407 (e.g., to an electronic wallet, a bank account application, a mobile application, and/or the like thereon). For example, second user device 407 may communicate a registration request to transaction service provider system 402.

In some non-limiting embodiments or aspects, registration may require the second user to provide identification verification, such as providing their name, address, social security number, driver's license number, picture of themselves, and/or the like. The identification verification may be included in the registration request, or transaction service provider system 402 may communicate an identification verification request to second user device 407 upon receipt of the registration request. Second user device 407 may communicate an identification verification response, which may include the identification verification, to transaction service provider system 402.

In some non-limiting embodiments or aspects, when the link is selected, the second user device 407 may be searched for any existing electronic wallets (e.g., electronic wallet mobile applications and/or the like). Additionally or alternatively, the second user may be able to select an existing electronic wallet to which the prepaid token will be provisioned. Additionally or alternatively, the second user may be prompted to install an electronic wallet (e.g., electronic wallet mobile applications and/or the like), which may be associated with transaction service provider system 402.

In some non-limiting embodiments or aspects, the transaction service provider system 402 may provision the prepaid token. For example, transaction service provider system 402 may communicate a confirmation request to issuer system 404. The issuer system 404 may communicate a confirmation message to the second user device 407. The confirmation message to second user device 407 may include a one-time password confirmation. Second user device 407 may communicate a response to the confirmation message to issuer system 404. Issuer system 404 may communicate a confirmation response to transaction service provider system 402. Based on the response from issuer system 404 (e.g., if issuer system 404 approves the confirmation), transaction service provider system 402 may generate the prepaid token.

In some non-limiting embodiments or aspects, transaction service provider system 402 may generate the prepaid token with a token vault. For example, the transaction service provider system 402 may communicate a token provisioning request to the token vault. The token provisioning request may include an identifier of the requesting user device, an identifier of the recipient user device, an identifier associated with the provisioning action, and/or the like. The token vault may communicate the prepaid token to transaction service provider system 402.

In some non-limiting embodiments or aspects, the initial account balance of the prepaid token may be equal to the monetary amount associated with the token creation request.

In some non-limiting embodiments or aspects, transaction service provider system 402 may register and bind the prepaid token to the second user device 407 (e.g., store the prepaid token with association with an identifier such that only second user device 407 may use the prepaid token). The prepaid token may be bound to a bank, electronic wallet, or application of the second user device 407. The second user may be able to use the prepaid token after registration of the prepaid token is complete. In some non-limiting embodiments or aspects, the transaction service provider system 402 may communicate the prepaid token account data to the first user device 406. The first user device 406 may then communicate the prepaid token account data to the second user device 407.

In some non-limiting embodiments or aspects, the prepaid token may be reloadable. Additionally or alternatively, the balance of a prepaid token may be merged into an existing prepaid token (e.g., the balance of the prepaid token may be added to the existing balance of the existing prepaid token). For example, the prepaid token may be merged with the existing prepaid token by transaction service provider system 402. For the purpose of illustration, upon registering of a prepaid token, transaction service provider system 402 may communicate a prompt to second user device 407 to determine if the second user wants to merge the registered prepaid token with an existing prepaid token. Second user device 407 may communicate to transaction service provide system 402 a request to merge the prepaid token and may communicate the prepaid token in which the new prepaid token should be merged into.

In some non-limiting embodiments or aspects, once the balance of a prepaid token is depleted (e.g., the balance is merged with another prepaid token or the entire balance is spent), the account identifier number (e.g., PAN and/or the like) associated with the prepaid token may be re-issued to another user, thus allowing the number (e.g., PAN) to be recycled and allowing the predetermined range of PAN values to more efficiently be used, which will also allow for a more narrow range of PAN values needed to be designated for use with the prepaid tokens. In some non-limiting embodiments or aspects, the depleted prepaid token may have to sit dormant (e.g., unused) for a predetermined time (e.g., 2 weeks, 6 months, etc.) before the prepaid token can be re-issued.

In some non-limiting embodiments or aspects, the first user may elect to send recurring prepaid tokens to the second user (e.g., parents sending monthly prepaid tokens to their children). The recurring prepaid tokens may be initiated on a periodic basis (e.g., monthly, quarterly, yearly, etc.), and the first user may select the period. The recurring prepaid tokens may occur for a predetermined duration. The first user may select the predetermined duration. The selected period and/or the selected predetermined duration for recurring prepaid tokens may be included in the token creation request.

In some non-limiting embodiments or aspects, the token creation request may include a predetermined duration (e.g., an expiration date and/or the like) for the prepaid token such that the balance on the prepaid token expires after the predetermined duration. Additionally or alternatively, at the end of the predetermined duration for the prepaid token, transaction service provider system 402 may communicate a rollover request to the second user device 407. If second user device 407 communicates a rollover response indicating an acceptance of the rollover request, transaction service provider system 402 may merge the remaining balance of the prepaid token to a new prepaid token. Transaction service provider system 402 may charge a fee for the rollover of the balance. Transaction service provider system 402 may provide APIs to the second user device 407 to rollover the balance. The rollover may include two transactions, a credit transaction for the new prepaid token receiving the funds, and an account funding transaction for the prepaid token sending the funds. In some non-limiting embodiments or aspects, the balance can be transferred to a token other than a prepaid token.

In some non-limiting embodiments or aspects, a user may be able to keep track of the prepaid tokens through a token account. The token account may show when new prepaid tokens are received, who sent the prepaid tokens, and the amount of the prepaid tokens, as well as each time the prepaid token is used, the amount of each use, and where it was used.

In some non-limiting embodiments or aspects, second user device 407 may communicate the token to a merchant system (e.g. merchant system 108). Additionally, the merchant system may communicate an authorization request to transaction service provider system 402 when attempting to use the prepaid token to make a transaction (e.g., a purchase). Transaction service provider system 402 and/or issuer system 404 may compare the transaction amount to the remaining balance on the prepaid token. If the transaction amount is equal to or less than the remaining balance, the transaction may be authorized and the balance of the prepaid token may be reduced by the transaction amount. If the transaction amount is greater than the remaining balance, the transaction may be denied.

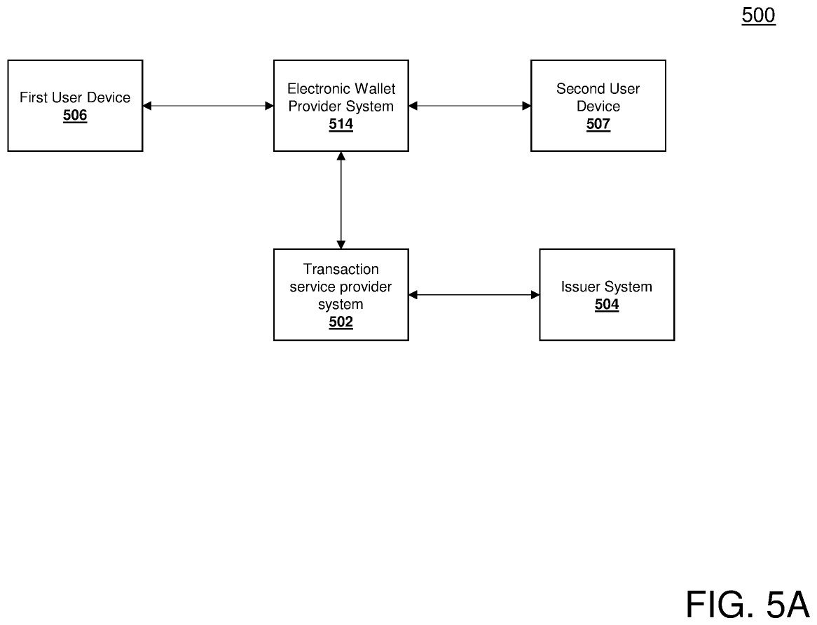

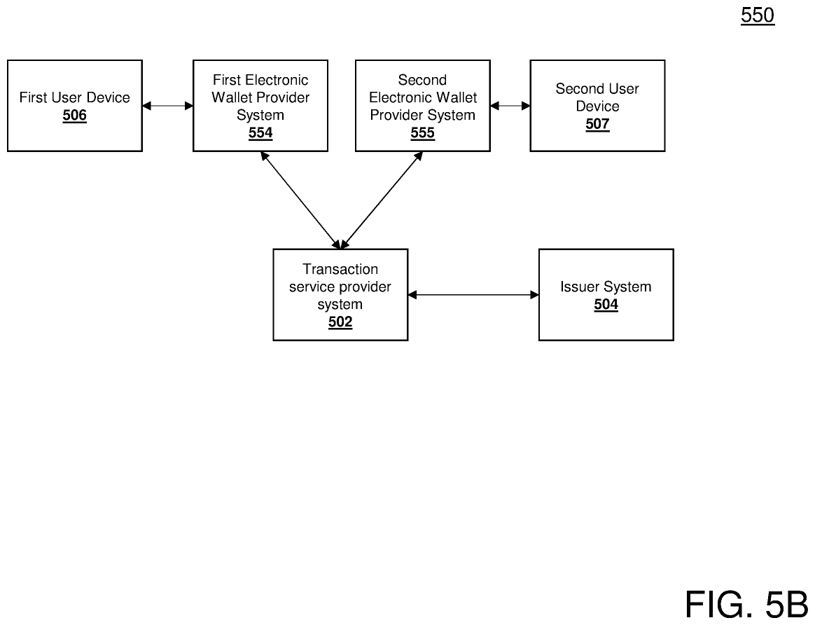

Referring now to FIG. 5A, shown is a diagram of an exemplary implementation 500 of a non-limiting embodiment or aspect of the present disclosure. As shown in FIG. 5A, implementation 500 may include a first user device 506, a second user device 507, an electronic wallet provider system 514, a transaction service provider system 502, an issuer system 504, and/or the like. In some non-limiting embodiments or aspects, first user device 506 and/or second user device 507 may be the same as or similar to user device 106. In some non-limiting embodiments or aspects, electronic wallet provider system 514 may be the same as or similar to electronic wallet provider system 114. In some non-limiting embodiments or aspects, transaction service provider system 502 may be the same as or similar to transaction service provider system 102. In some non-limiting embodiments or aspects, issuer system 504 may be the same as or similar to issuer system 104.

In some non-limiting embodiments or aspects, a first user may communicate a token creation notification to a second user through electronic wallet provider system 514 (e.g., a single electronic wallet service provider system 514). For example, the generated token communicated to the second user may be associated with a token of the first user. Additionally or alternatively, the first user may communicate a token creation request through a first user device 506 to the electronic wallet provider system 514, as described herein.

In some non-limiting embodiments or aspects, the token creation request may be communicated, for example, through a mobile application on the user's device (e.g., first user device 506), a website, telephone call, and/or the like. The mobile application may be associated with electronic wallet provider system 514, transaction service provider system 502, issuer system 504, and/or the like. The token creation request may include token information, monetary amount data, validity duration, account data, merchant data, and/or the like. Token information may include a token identifier, user identifier, electronic wallet provider of the token, and/or the like. Merchant data may include merchant name, merchant category code, and/or the like. The merchant name may be derived from the card acceptor field of an authorization request message (e.g., ISO field 43 of ISO8583). In some non-limiting embodiments or aspects, the merchant data may be optional. The monetary amount data may include a total amount limit (e.g., maximum total amount with which the token can be charged in its life span), currency code, and/or the like. Validity duration may include a validity length (e.g., a period of time such as one week, one month, one year, and/or the like; an expiration date, any combination thereof, and/or the like) that the generated token may be valid.

In some non-limiting embodiments or aspects, the generated token may not be used for transactions after the validity period. The validity length may also be based on a specified date designated by the first user to indicate the last day of validity of the generated token. The token creation request may also include identifier information of second user device 507. The identifier information of second user device 507 may include electronic wallet provider, electronic wallet provider identifier, an application account, phone number, name of user, email address, and/or the like. The first user may select the token to be included in the token creation request. The selected token may be chosen from a list of tokens available on first user device 506. The electronic wallet provider system 514 may retrieve a reference identifier based on the token selected for the token creation request.

In some non-limiting embodiments or aspects, the electronic wallet provider system 514 may communicate the token creation request, payment token data, reference identifier, monetary amount data, validity duration, account data, merchant data, and/or the like to transaction service provider system 502. Transaction service provider system 502 may retrieve an account identifier of the first user based on the reference identifier. By using a reference identifier, the first user is able to communicate the token creation request without revealing their actual account identifier, or other privacy impact assessment data.

In some non-limiting embodiments or aspects, transaction service provider system 502 may send a validation request to issuer system 504. Issuer system 504 may check to ensure the account identifier is valid and that the account identifier can be used to generate a token for a second user.

In some non-limiting embodiments or aspects, transaction service provider system 502 may determine a reference identifier of the first user based on the payment token data and transaction service provider system 502 may communicate the reference identifier to issuer system 504. Issuer system 504 may determine the account identifier of the first user based on the reference identifier. Issuer system 504 may communicate a response to the validation request to transaction service provider system 502. The response to the validation request may be approved or declined.

In some non-limiting embodiments or aspects, in response to receiving the response to the validation request, transaction service provider system 502 may communicate a response to the token creation request to electronic wallet provider system 514. The response to the token creation request may be an approval or a denial. If the token creation request is an approval, electronic wallet provider system 514 may communicate a token creation notification to a second user device 507. Electronic wallet provider system 514 may communicate to second user device 507 based on the second user identifier provided by first user device 506. The token creation notification may notify the second user that a token creation request has been made by a first user for use of the second user and may direct the second user to accept or decline the creation of a generated payment token. The second user may respond to the token creation notification through second user device 507. If the token creation notification is accepted by second user device 507, electronic wallet provider system 514 may communicate a confirmation of the acceptance to first user device 506. Payment token data associated with a generated payment token may be communicated to second user device 507 based on the response to the token creation notification.

Referring now to FIG. 5B, shown is a diagram of an exemplary implementation 550 of a non-limiting embodiment or aspect of the present disclosure. As shown in FIG. 5B, implementation 550 may include a first user device 506, a second user device 507, a first electronic wallet provider system 554, a second electronic wallet provider system 555, a transaction service provider system 502, an issuer system 504, and/or the like. In some non-limiting embodiments or aspects, first user device 506 and second user device 507 may be the same as or similar to user device 106. In some non-limiting embodiments or aspects, first electronic wallet provider system 554 and/or second electronic wallet provider system 555 may be the same as or similar to electronic wallet provider system 114. In some non-limiting embodiments or aspects, transaction service provider system 502 may be the same as or similar to the transaction service provider system 102. In some non-limiting embodiments or aspects, issuer system 504 may be the same as or similar to issuer system 104.

In some non-limiting embodiments or aspects, the implementation 550 may be similar to the implementation 500, except that first user device 506 and second user device 507 may not use the same electronic wallet provider system (e.g., electronic wallet provider system 514) For example, first user device 506 and second user device 507 may use two separate electronic wallet provider systems, a first electronic wallet provider system 554 and a second electronic wallet provider system 555, respectively. A first user may communicate a token creation notification to a second user through a first electronic wallet provider system 554. The token communicated to the second user may be associated with a token of the first user. The first user may communicate a token creation request through a first user device 506 to first electronic wallet provider system 554. The token creation request may be communicated, for example, through a mobile application on the user's device, a website, telephone call, and/or the like. The mobile application may be associated with the first electronic wallet provider system 554.

In some non-limiting embodiments or aspects, the token creation request may include token information, monetary amount data, validity duration, account data, merchant data, and/or the like. The token creation request may also include identifier information of second user device 507 and/or identifier information of the second electronic wallet provider. The identifier information of second user device 507 may include an app account, phone number, name of user, email address, and/or the like. The identifier information of the second electronic wallet provider may include the name of the second electronic wallet provider, the contact information of second electronic wallet provider system 555, and/or the like. The first user may select the token to be included in the token creation request. The selected token may be chosen from a list of tokens available on first user device 506. First electronic wallet provider system 554 may retrieve a reference identifier based on the token selected for the token creation request.

In some non-limiting embodiments or aspects, first electronic wallet provider system 554 may communicate the token creation request, payment token data, reference identifier, monetary amount data, validity duration, account data, merchant data, and/or the like to the transaction service provider system 502. Transaction service provider system 502 may retrieve an account identifier of the first user based on the reference identifier. Transaction service provider system 502 may send a validation request to issuer system 504. Issuer system 504 may check to ensure the account identifier is valid and that the account identifier can be used to generate a token for a second user. In non-limiting embodiments or aspects, transaction service provider system 502 may determine a reference identifier of the first user based on the payment token data received from first electronic wallet provider system 554 and transaction service provider system 502 may communicate the reference identifier to issuer system 504. Issuer system 504 may determine the account identifier of the first user based on the reference identifier. Issuer system 504 may communicate a response to the validation request to transaction service provider system 502. The response to the validation request may be approved or declined.

In some non-limiting embodiments or aspects, in response to receiving the response to the validation request, transaction service provider system 502 may communicate a token creation request to second electronic wallet provider system 555. Second electronic wallet provider system 555 may communicate a token creation notification to a second user device 507. Second electronic wallet provider system 555 may communicate to second user device 507 based on the second user identifier provided by first user device 506. The token creation notification may notify the second user that a token creation request has been made by a first user for use of the second user and may direct the second user to accept or decline the creation of a second payment token.

In some non-limiting embodiments or aspects, the second user may respond to the token creation notification through second user device 507. If the token creation notification is accepted by second user device 507, second electronic wallet provider system 555 may communicate a confirmation of the acceptance to transaction service provider system 502. Transaction service provider system 502 may communicate the confirmation to first electronic wallet provider system 554. First electronic wallet provider system 554 may communicate the confirmation to first user device 506. Payment token data associated with a second payment token may be communicated to second user device 507 based on the response to the token creation notification.

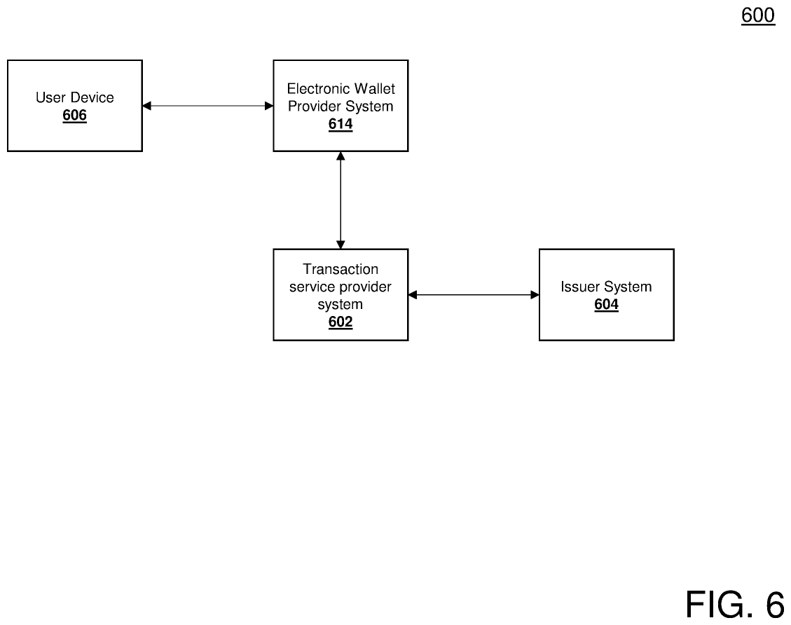

Referring now to FIG. 6, shown is a diagram of an exemplary implementation 600 of a non-limiting embodiment or aspect of the present disclosure. As shown in FIG. 6, implementation 600 may include a user device 606, an electronic wallet provider system 614, a transaction service provider system 602, an issuer system 604, and/or the like. In some non-limiting embodiments or aspects, user device 606 may be the same as or similar to user device 106. In some non-limiting embodiments or aspects, electronic wallet provider system 614 may be the same as or similar to electronic wallet provider system 114. In some non-limiting embodiments or aspects, transaction service provider system 602 may be the same as or similar to transaction service provider system 102. In some non-limiting embodiments or aspects, issuer system 604 may be the same as or similar to issuer system 104.

In some non-limiting embodiments or aspects, a user may enroll their payment method with the transaction service provider. The user may enroll their payment method after receiving confirmation from the second user that the second user accepted a token creation, such as in process 500 or process 550. The user may communicate a token enrollment request through a user device 606 to electronic wallet provider system 614. The token enrollment request may be communicated, for example, through a mobile application on the user's device, a website, telephone call, and/or the like. The mobile application may be associated with electronic wallet provider system 614, transaction service provider system 602, merchant, and/or the like. The token creation request may include account identifier information.

In some non-limiting embodiments or aspects, electronic wallet provider system 614 may communicate an enrollment request to transaction service provider system 602. Transaction service provider system 602 may perform a validation check to determine if the account identifier is eligible for tokenization. In some non-limiting embodiments or aspects, transaction service provider system 602 may communicate an eligibility request to an issuer system 604. Issuer system 604 may then determine if the account identifier is eligible for tokenization. Issuer system 604 may then communicate the eligibility of the account identifier to the transaction service provider system 602. Issuer system 604 may also communicate card metadata associated with the account identifier to transaction service provider system 602. If the account identifier is eligible for tokenization, transaction service provider system 602 may communicate card art (e.g., image and/or graphic representation of the token), terms and conditions of the issuer, and card metadata to electronic wallet provider system 614.

In some non-limiting embodiments or aspects, token provisioning may begin after the terms and conditions are accepted by the first user. Electronic wallet provider system 614 may communicate the terms and conditions to first user device 606. The terms and conditions may be displayed on a mobile application on first user device 606. The first user may accept or decline the terms and conditions. A response to the terms and conditions may be communicated by first user device 606 to electronic wallet provider system 614.

In some non-limiting embodiments or aspects, in response to receiving an acceptance of the terms and conditions, electronic wallet provider system 614 may communicate a request to provision a token to transaction service provider system 602. The request to provision a token may include identity and verification data. In response receiving the request to provision a token, transaction service provider system 602 may communicate a token activation request to issuer system 604. The token activation request may include the identity and verification data. Issuer system 604 may approve or deny the token activation request and communicate the response to transaction service provider system 602. The approval of the token activation request may be complete without any addition step-up authorization requirements. The token activation request may also be approved based on risk management rules of the transaction service provider.

In some non-limiting embodiments or aspects, in response to approval of the token activation request, transaction service provider system 602 may generate a generated token. The generated token may include an amount limit, validity length, merchant restrictions, and/or the like. The amount limit may be based on the monetary amount data. The amount limit may be a monetary value (e.g., a numerical value) that is the maximum cumulative charges that the generated token can be used to make payment transactions. The amount limit may be in a currency designated in the monetary amount data, or may be in a predetermined default currency. The predetermined default currency may be determined by the transaction service provider. The validity length may be a period of time (e.g., one week, one month, one year, and/or the like) that the generated token may be valid. The generated token may not be used for transactions after the validity period. The validity length may also be based on a specified date designated by the first user to indicate the last day of validity of the generated token. The merchant restrictions may include one or more merchants and/or merchant category codes. The merchant restrictions may allow the generated token to only be used with the designated merchants and/or merchant category codes.

In some non-limiting embodiments or aspects, the merchant restrictions may allow the generated token to be used at any merchant and/or merchant category codes, except those designated by the merchant restrictions.

In some non-limiting embodiments or aspects, the transaction service provider system 602 may communicate the generated token data to electronic wallet provider system 614. Transaction service provider system 602 may also communicate a notification message to issuer system 604. The notification message to issuer system 604 may indicate that the generated token was created. Electronic wallet provider system 614 may communicate a confirmation to transaction service provider system 602 that the generated token was provisioned. In response to receiving the confirmation from electronic wallet provider system 614, transaction provider system 602 may communicate a notification to issuer system 604 that the generated token was provisioned.

In some non-limiting embodiments or aspects, the second user may initiate transactions with the generated token data with user device 606. The generated token data may be linked to the first user's token data. When transaction service provider system 602 receives an authorization request with the generated token data, transaction service provider system 602 may modify the authorization request. The modified authorization request may contain the same fields as the original authorization request, except the generated token data may be replaced with the first user's token data. Therefore, the first user's token may be debited for approved charges made with the generated token. If no transactions are initiated with the second user's token, no debits may be made against the first user's token.

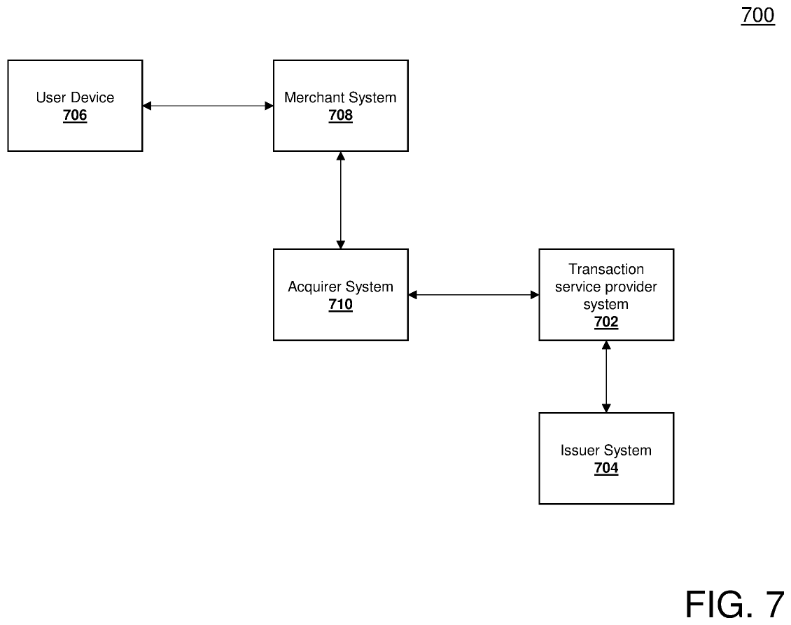

Referring now to FIG. 7, shown is a diagram of an exemplary implementation 700 of a non-limiting embodiment or aspect of the present disclosure. As shown in FIG. 7, implementation 700 may include a user device 706, a merchant system 708, an acquirer system 710, a transaction service provider system 702, an issuer system 704, and/or the like. In some non-limiting embodiments or aspects, user device 706 may be the same as or similar to user device 106. Merchant system 708 may be the same as or similar to, merchant system 108, acquirer system 710 may be the same as or similar to acquirer system 110, transaction service provider system 702 may be the same as or similar to transaction service provider system 102, and issuer system 704 may be the same as or similar to issuer system 104.

In some non-limiting embodiments or aspects, once the prepaid token from process 400 or generated token from process 600 is provisioned or bound to user device 706, the user may initiate a transaction with the second token (e.g., prepaid token, generated token, and/or the like). The user may communicate an authorization request to an electronic wallet provider system to initiate the transaction with the token. The user may initiate a transaction with a merchant system 708. The transaction may be initiated at a POS device of merchant system 708. The transaction may be initiated with a user device 706 communicating a transaction request to merchant system 708. The user device 706 and merchant system 708 may have near field communication (NFC) capabilities. User device 706 may communicate transaction details to merchant system 708. The transaction details may include the transaction amount, currency, token data, and/or the like. Merchant system 708 may communicate the transaction details, as well as merchant data to acquirer system 710.

In some non-limiting embodiments or aspects, acquirer system 710 may parse the transaction details. Acquirer system 710 may communicate the token-based transaction to transaction service provider system 702. Transaction service provider system 702 may validate the second token. The second token may be validated with the token vault. Validation of the second token may include validity, total amount limit, and merchant name. The validity validation may ensure that the second token is still valid at the time of the transaction. The total amount limit validation may ensure that the transaction amount is less than the amount limit of the second token.

In some non-limiting embodiments or aspects, there may be a plurality of authorization requests associated with the second token. The plurality of authorization requests may include the current authorization request as well as at least one previous authorization request. The current authorization request may include the current transaction amount, and each previous authorization request may include their own respective transaction amounts. Validating the total amount limit may include taking the sum of the current transaction amount and all previous transaction amounts associated with the second token. Transaction service provider system 702 may ensure that the sum is less than or equal to the amount limit. The merchant name validation may ensure that the merchant of the transaction meets the requirements of the merchant restrictions. Transaction service provider system 702 may ensure that the merchant name is included in the list of designated allowed businesses, or is not included in the list of designated not allowed businesses. The merchant name validation may also ensure that the merchant category code of the merchant is an allowed merchant category code for the second token. If the second token satisfies the validation conditions, transaction service provider system 702 may perform detokenization and route the transaction to issuer system 704. The routing of the transaction may follow predetermined settings of issuer system 704.

In some non-limiting embodiments or aspects, issuer system 704 may perform a validation of the transaction. Issuer system 704 may communicate a response to transaction service provider system 702. Transaction service provider system 702 may process the response from issuer system 704. Transaction service provider system 702 may authorize the transaction based on the response and perform tokenization. Transaction service provider system 702 may communicate a response to acquirer system 710. Acquirer system 710 may communicate a notification to merchant system 708. Merchant system 708 may display a notification to the user (e.g., approved or declined transaction). Merchant system 708 may also communicate the approval or declination of the transaction to the electronic wallet provider system of the token.

In some non-limiting embodiments or aspects, the prepaid token and generated token may not be restricted to any specific jurisdiction. The tokens may be used in any part of the world once they are created. If a merchant has the infrastructure to accept token payments, the merchant will be able to accept the second token without any additional merchant infrastructure changes. A single token of the first user may be associated with multiple prepaid and/or generated tokens.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

1. A computer-implemented method, comprising:
receiving, with at least one processor, a token creation request from a first user device of a first user, wherein the token creation request comprises first payment token data associated with a first payment token provisioned to the first user device, monetary amount data associated with a monetary amount, a selection of a recurring period, and a selection of a duration;
communicating, with the at least one processor, an approval request based on the token creation request to an issuer system;
receiving, with the at least one processor, an approval response based on the approval request from the issuer system;
generating, with the at least one processor, a second payment token based on the approval response;
communicating, with the at least one processor, second payment token data associated with the second payment token to a second user device of a second user;
receiving, with the at least one processor, a registration request from the second user device, wherein the registration request comprises identification verification data of the second user;
generating, with the at least one processor, at least one recurring payment token; and
communicating, with the at least one processor, the at least one recurring payment token to the second user device of the second user at each recurring period within the duration.

2. The computer-implemented method of claim 1, further comprising:
determining, with the at least one processor, a reference identifier of the first user based on the first payment token data, wherein the approval request comprises the reference identifier of the first user, wherein the issuer system determines an account number of the first user based on the reference identifier.

3. The computer-implemented method of claim 1, wherein communicating the second payment token data to the second user device comprises:
communicating, with the at least one processor, a notification to the second user device;
receiving, with the at least one processor, a response from the second user device; and
communicating, with the at least one processor, the second payment token data to the second user device based on the response.

4. The computer-implemented method of claim 1, wherein the method further comprises:
receiving, with the at least one processor, a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount;
determining, with the at least one processor, a sum of the current transaction amount of the current authorization request and each respective previous transaction amount of the at least one previous authorization request;
determining, with the at least one processor, the sum is less than or equal to the monetary amount; and
communicating, with the at least one processor, a modified authorization request comprising the first payment token based on determining the sum is less than or equal to the monetary amount.

5. The computer-implemented method of claim 1, wherein the second payment token is associated with an initial account balance equal to the monetary amount.

6. The computer-implemented method of claim 5, further comprising:
debiting, with the at least one processor, an account of the first user an amount equal to the monetary amount prior to communicating the approval request to the issuer system.

7. The computer-implemented method of claim 1, wherein communicating the second payment token data to the second user device further comprises:
communicating, with the at least one processor, the second payment token data to the first user device, wherein the first user device communicates the second payment token data to the second user device.

8. A system, comprising:
at least one processor; and
at least one non-transitory computer-readable medium including one or more instructions that, when executed by the at least one processor, cause the at least one processor to:
receive a token creation request from a first user device of a first user, wherein the token creation request comprises first payment token data associated with a first payment token provisioned to the first user device, monetary amount data associated with a monetary amount, selection of a recurring period, and a selection of a duration;
communicate an approval request based on the token creation request to an issuer system;
receive an approval response based on the approval request from the issuer system;
generate a second payment token based on the approval response;
communicate second payment token data associated with the second payment token to a second user device of a second user;
receive a registration request from the second user device, wherein the registration request comprises identification verification data of the second user;
generate at least one recurring payment token; and
communicate the at least one recurring payment token to the second user device of the second user at each recurring period within the duration.

9. The system of claim 8, wherein the one or more instructions further cause the at least one processor to:
determine a reference identifier of the first user based on the first payment token data, wherein the approval request comprises the reference identifier of the first user, wherein the issuer system determines an account number of the first user based on the reference identifier.

10. The system of claim 8, wherein communicating the second payment token data to the second user device comprises:
communicating a notification to the second user device;
receiving a response from the second user device; and
communicating the second payment token data to the second user device based on the response.

11. The system of claim 8, wherein the one or more instructions further cause the at least one processor to:
receive a plurality of authorization requests comprising the second payment token, the plurality of authorization requests comprising a current authorization request and at least one previous authorization request, the current authorization request comprising a current transaction amount, and each previous authorization request comprising a respective previous transaction amount;
determine a sum of the current transaction amount of the current authorization request and each respective previous transaction amount of the at least one previous authorization request;
determine the sum is less than or equal to the monetary amount; and
communicate a modified authorization request comprising the first payment token based on determining the sum is less than or equal to the monetary amount.

12. The system of claim 8, wherein the second payment token is associated with an initial account balance equal to the monetary amount.

13. The system of claim 12, wherein the one or more instructions further cause the at least one processor to:
debit an account of the first user an amount equal to the monetary amount prior to communicating the approval request to the issuer system.

14. The system of claim 8, wherein communicating the second payment token data to the second user device further comprises:
communicating the second payment token data to the first user device, wherein the first user device communicates the second payment token data to the second user device.

15. A computer program product comprising at least one non-transitory computer-readable medium including one or more instructions that, when executed by at least one processor, cause the at least one processor to:
receive a token creation request from a first user device of a first user, wherein the token creation request comprises first payment token data associated with a first payment token provisioned to the first user device, monetary amount data associated with a monetary amount, a selection of a recurring period, and a selection of a duration;
communicate an approval request based on the token creation request to an issuer system;
receive an approval response based on the approval request from the issuer system;
generate a second payment token based on the approval response;
communicate second payment token data associated with the second payment token to a second user device associated with a second user;
receive a registration request from the second user device, wherein the registration request comprises identification verification data of the second user;
generate at least one recurring payment token; and
communicate the at least one recurring payment token to the second user device of the second user at each recurring period within the duration.

16. The computer program product of claim 15, wherein the one or more instructions further cause the at least one processor to:
determine a reference identifier of the first user based on the first payment token data, wherein the approval request comprises the reference identifier of the first user, wherein the issuer system determines an account number of the first user based on the reference identifier.

17. The computer program product of claim 15, wherein communicating the second payment token data to the second user device comprises:
communicating a notification to the second user device;
receiving a response from the second user device; and
communicating the second payment token data to the second user device based on the response.

18. The computer program product of claim 15, wherein the one or more instructions further cause the at least one processor to:
receive a plurality of authorization requests, each authorization request of the plurality of authorization requests comprising the second payment token, the plurality of authorization requests comprising a current authorization request and at least one previous authorization request, the current authorization request comprising a current transaction amount, and each previous authorization request comprising a respective previous transaction amount;
determine a sum of the current transaction amount of the current authorization request and each respective previous transaction amount of the at least one previous authorization request;
determine the sum is less than or equal to the monetary amount; and
communicate a modified authorization request comprising the first payment token based on determining the sum is less than or equal to the monetary amount.

19. The computer program product of claim 15, wherein the second payment token is associated with an initial account balance equal to the monetary amount.

20. The computer program product of claim 15, wherein communicating the second payment token data to the second user device further comprises:
communicating the second payment token data to the first user device, wherein the first user device communicates the second payment token data to the second user device.
